(19) United States
(12) Patent Application Publication
(10) Pub. No.: US 2026/0332348 A1
(43) Pub. Date: Oct. 22, 2026

(54) MULTI-SINE WAVEFORM FOR PASSIVE DEVICE

(71) Applicant: QUALCOMM Incorporated, San Diego, CA (US)

(72) Inventors: Kangqi LIU, San Diego, CA (US); Jing LEI, San Diego, CA (US); Chao WEI, Beijing (CN); Hao XU, Beijing (CN)

(21) Appl. No.: 19/114,155

(22) PCT Filed: Dec. 2, 2022
(86) PCT No.: PCT/CN2022/136129

§ 371 Date: Mar. 21, 2025

(51) Int. Cl. H04L 5/00; H04L 5/02; H04W 72/0446; H04W 72/0453; H04W 72/20

(52) U.S. Cl. CPC H04L 5/0053; H04L 5/02; H04W 72/0446; H04W 72/0453; H04W 72/20

(57) ABSTRACT

Various aspects of the present disclosure generally relate to wireless communication. In some aspects, a first device may transmit, to a second device, control information that configures the second device to operate as a passive device in association with selection of a multi-sine waveform. The first device may transmit the multi-sine waveform based at least in part on the control information. Numerous other aspects are described.

### FIELD OF THE DISCLOSURE

Aspects of the present disclosure generally relate to wireless communication and to techniques and apparatuses for using a multi-sine waveform for a passive device.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a first device. The method may include transmitting, to a second device, control information that configures the second device to operate as a passive device in association with selection of a multi-sine waveform. The method may include transmitting the multi-sine waveform based at least in part on the control information.

Some aspects described herein relate to a method of wireless communication performed by a second device. The method may include receiving, from a first device, control information that configures the second device to operate as a passive device in association with selection of a multi-sine waveform. The method may include receiving the multi-sine waveform. The method may include selecting the multi-sine waveform based at least in part on the control information. The method may include transmitting an indication of the selected multi-sine waveform.

Some aspects described herein relate to a method of wireless communication performed by a third device. The method may include receiving backscattered data from a second device that is associated with a multi-sine waveform transmitted by a first device. The method may include transmitting waveform selection feedback for the backscattered data based at least in part on waveform parameters that include one or more of a period length of the multi-sine waveform, a quantity of frequency components of the multi-sine waveform, or a bandwidth of the multi-sine waveform.

Some aspects described herein relate to a first device for wireless communication. The first device may include a memory and one or more processors coupled to the memory. The one or more processors may be configured to transmit, to a second device, control information that configures the second device to operate as a passive device in association with selection of a multi-sine waveform. The one or more processors may be configured to transmit the multi-sine waveform based at least in part on the control information.

Some aspects described herein relate to a second device for wireless communication. The second device may include a memory and one or more processors coupled to the memory. The one or more processors may be configured to receive, from a first device, control information that configures the second device to operate as a passive device in association with selection of a multi-sine waveform. The one or more processors may be configured to receive the multi-sine waveform. The one or more processors may be configured to select the multi-sine waveform based at least in part on the control information. The one or more processors may be configured to transmit an indication of the selected multi-sine waveform.

Some aspects described herein relate to a third device for wireless communication. The third device may include a memory and one or more processors coupled to the memory. The one or more processors may be configured to receive backscattered data from a second device that is associated with a multi-sine waveform transmitted by a first device. The one or more processors may be configured to transmit waveform selection feedback for the backscattered data based at least in part on waveform parameters that include one or more of a period length of the multi-sine waveform, a quantity of frequency components of the multi-sine waveform, or a bandwidth of the multi-sine waveform.

Some aspects described herein relate to a non-transitory computer-readable medium that stores a set of instructions for wireless communication by a first device. The set of instructions, when executed by one or more processors of the first device, may cause the first device to transmit, to a second device, control information that configures the second device to operate as a passive device in association with selection of a multi-sine waveform. The set of instructions, when executed by one or more processors of the first device, may cause the first device to transmit the multi-sine waveform based at least in part on the control information.

Some aspects described herein relate to a non-transitory computer-readable medium that stores a set of instructions for wireless communication by a second device. The set of instructions, when executed by one or more processors of the second device, may cause the second device to receive, from a first device, control information that configures the second device to operate as a passive device in association with selection of a multi-sine waveform. The set of instructions, when executed by one or more processors of the second device, may cause the second device to receive the multi-sine waveform. The set of instructions, when executed by one or more processors of the second device, may cause the second device to select the multi-sine waveform based at least in part on the control information. The set of instructions, when executed by one or more processors of the second device, may cause the second device to transmit an indication of the selected multi-sine waveform.

Some aspects described herein relate to a non-transitory computer-readable medium that stores a set of instructions for wireless communication by a third device. The set of instructions, when executed by one or more processors of the third device, may cause the third device to receive backscattered data from a second device that is associated with a multi-sine waveform transmitted by a first device. The set of instructions, when executed by one or more processors of the third device, may cause the third device to transmit waveform selection feedback for the backscattered data based at least in part on waveform parameters that include one or more of a period length of the multi-sine waveform, a quantity of frequency components of the multi-sine waveform, or a bandwidth of the multi-sine waveform.

Some aspects described herein relate to an apparatus for wireless communication. The apparatus may include means for transmitting, to another apparatus, control information that configures the second device to operate as a passive device in association with selection of a multi-sine waveform. The apparatus may include means for transmitting the multi-sine waveform based at least in part on the control information.

Some aspects described herein relate to an apparatus for wireless communication. The apparatus may include means for receiving, from another apparatus, control information that configures the second device to operate as a passive device in association with selection of a multi-sine waveform. The apparatus may include means for receiving the multi-sine waveform. The apparatus may include means for selecting the multi-sine waveform based at least in part on the control information. The apparatus may include means for transmitting an indication of the selected multi-sine waveform.

Some aspects described herein relate to an apparatus for wireless communication. The apparatus may include means for receiving backscattered data from another apparatus that is associated with a multi-sine waveform transmitted by a radio frequency source. The apparatus may include means for transmitting waveform selection feedback for the backscattered data based at least in part on waveform parameters that include one or more of a period length of the multi-sine waveform, a quantity of frequency components of the multi-sine waveform, or a bandwidth of the multi-sine waveform.

Aspects generally include a method, apparatus, system, computer program product, non-transitory computer-readable medium, user equipment, wireless device, base station, network entity, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network entity in communication with a user equipment (UE) in a wireless network, in accordance with the present disclosure.

FIG. 3 is a diagram illustrating an example of a disaggregated base station, in accordance with the present disclosure.

FIG. 4 is a diagram illustrating an example of energy harvesting, in accordance with the present disclosure.

FIG. 5 is a diagram illustrating an example of backscatter communication, in accordance with the present disclosure.

FIG. 6 is a diagram illustrating examples of backscattering occasions, in accordance with the present disclosure.

FIG. 7 is a diagram illustrating an example of a multi-sine waveform sweeping scheme, in accordance with the present disclosure.

FIG. 8 is a diagram illustrating an example associated with multi-sine waveform selection, in accordance with the present disclosure.

FIG. 9 is a diagram illustrating an example associated with multi-sine waveform selection, in accordance with the present disclosure.

FIG. 10 is a diagram illustrating an example associated with multi-sine waveform selection, in accordance with the present disclosure.

FIG. 11 is a diagram illustrating an example of waveform selection, in accordance with the present disclosure.

FIG. 12 is a diagram illustrating an example of group backscattering, in accordance with the present disclosure.

FIG. 13 is a diagram illustrating an example process performed, for example, by a first device, in accordance with the present disclosure.

FIG. 14 is a diagram illustrating an example process performed, for example, by a second device, in accordance with the present disclosure.

FIG. 15 is a diagram illustrating an example process performed, for example, by a third device, in accordance with the present disclosure.

FIG. 16 is a diagram of an example apparatus for wireless communication, in accordance with the present disclosure.

FIG. 17 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

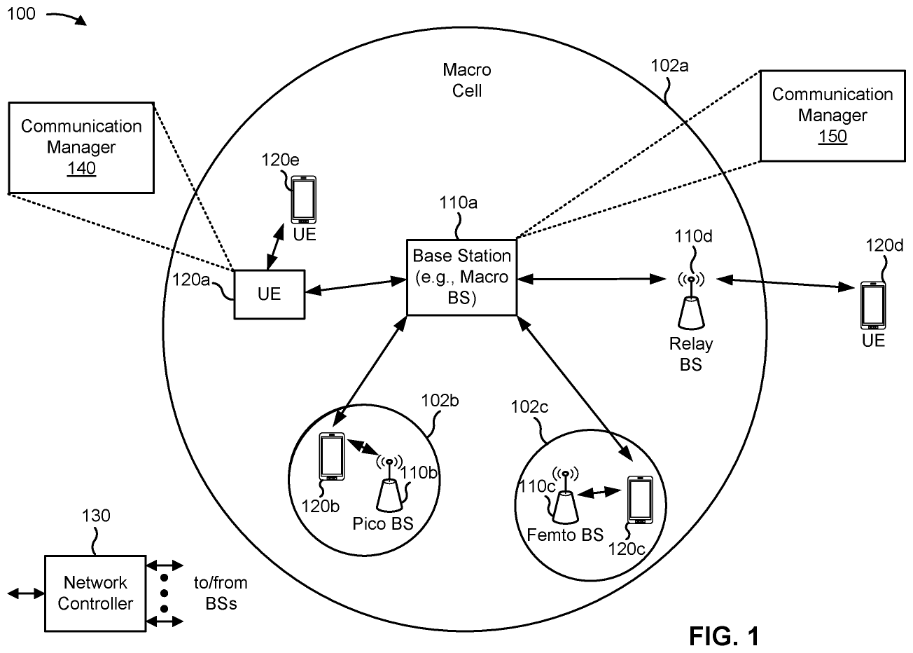

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include a user equipment (UE) 120 or multiple UEs 120 (shown as a UE 120a, a UE 120b, a UE 120c, a UE 120d, and a UE 120e). The wireless network 100 may also include one or more network entities, such as base stations 110 (shown as a BS 110a, a BS 110b, a BS 110c, and a BS 110d), and/or other network entities. A base station 110 is a network entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network entities in the wireless network 100 through various types of backhaul interfaces, such as a direct physical connection or a virtual network, using any suitable transport network.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

The wireless network 100 may include one or more relay stations. A relay station is a network entity that can receive a transmission of data from an upstream station (e.g., a network entity or a UE 120) and send a transmission of the data to a downstream station (e.g., a UE 120 or a network entity). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network with network entities that include different types of BSs, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of network entities and may provide coordination and control for these network entities. The network controller 130 may communicate with the base stations 110 via a backhaul communication link. The network entities may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network entity, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network entity as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a first device (e.g., UE 120, base station 110) may include a communication manager 140 or 150. As described in more detail elsewhere herein, the communication manager 140 or 150 may transmit, to a second device, control information that configures the second device to operate as a passive device in association with selection of a multi-sine waveform; and transmit the multi-sine waveform based at least in part on the control information.

In some aspects, a second device (e.g., an IoT device, a passive UE, a tag, a zero power device, a UE 120, an energy harvesting device) may include a communication manager 140. As described in more detail elsewhere herein, the communication manager 140 may receive, from a first device, control information that configures the second device to operate as a passive device in association with selection of a multi-sine waveform; receive the multi-sine waveform; select the multi-sine waveform based at least in part on the control information; and transmit an indication of the selected multi-sine waveform. Additionally, or alternatively, the communication manager 140 may perform one or more other operations described herein.

In some aspects, a third device (e.g., UE 120, base station 110) may include a communication manager 140 or 150. As described in more detail elsewhere herein, the communication manager 140 or 150 may receive backscattered data from a second device that is associated with a multi-sine waveform transmitted by a first device; and transmit waveform selection feedback for the backscattered data based at least in part on waveform parameters that include one or more of a period length of the multi-sine waveform, a quantity of frequency components of the multi-sine waveform, or a bandwidth of the multi-sine waveform. Additionally, or alternatively, the communication manager 140 or 150 may perform one or more other operations described herein.

As indicated above, FIG. 1 is provided as an example. Other examples may differ from what is described with regard to FIG. 1.

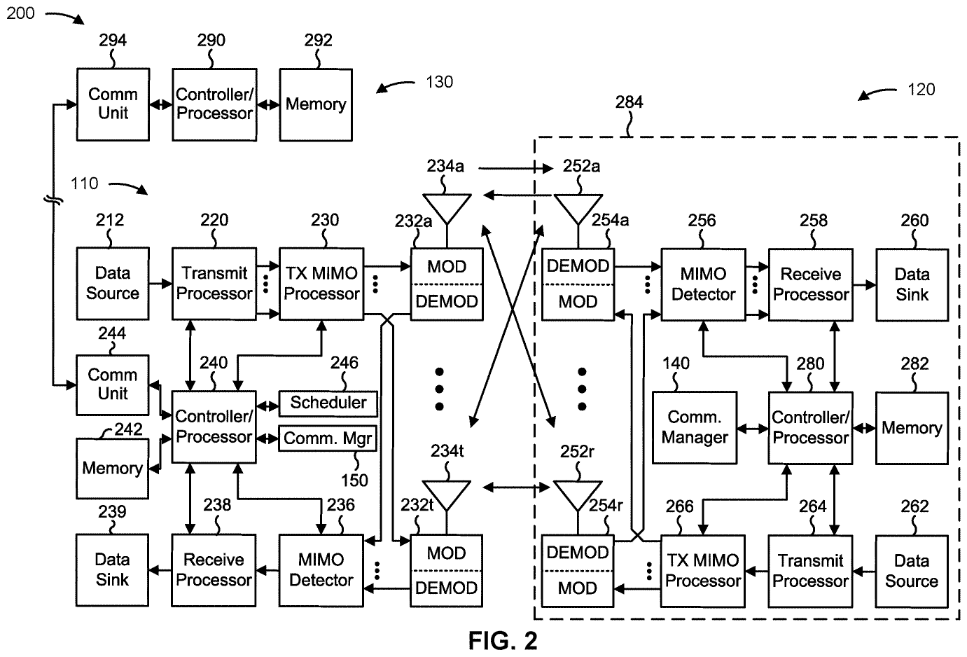

FIG. 2 is a diagram illustrating an example 200 of a network entity (e.g., base station 110) in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network entity via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

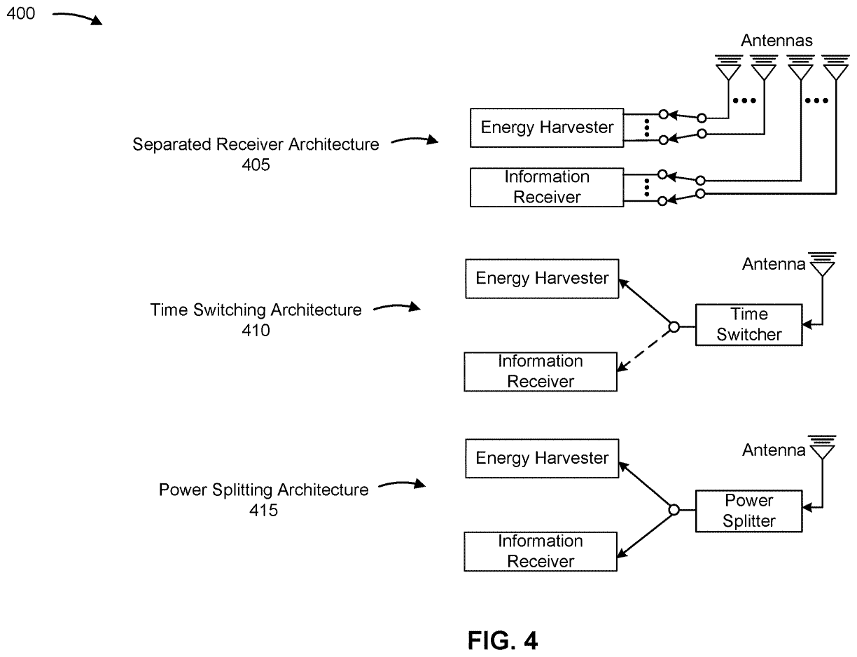

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network entity. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-17).

At the network entity (e.g., base station 110), the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network entity may include a communication unit 244 and may communicate with the network controller 130 via the communication unit 244. The network entity may include a scheduler 246 to schedule one or more UEs 120 for downlink and/or uplink communications. In some examples, the modem 232 of the network entity may include a modulator and a demodulator. In some examples, the network entity includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-17).

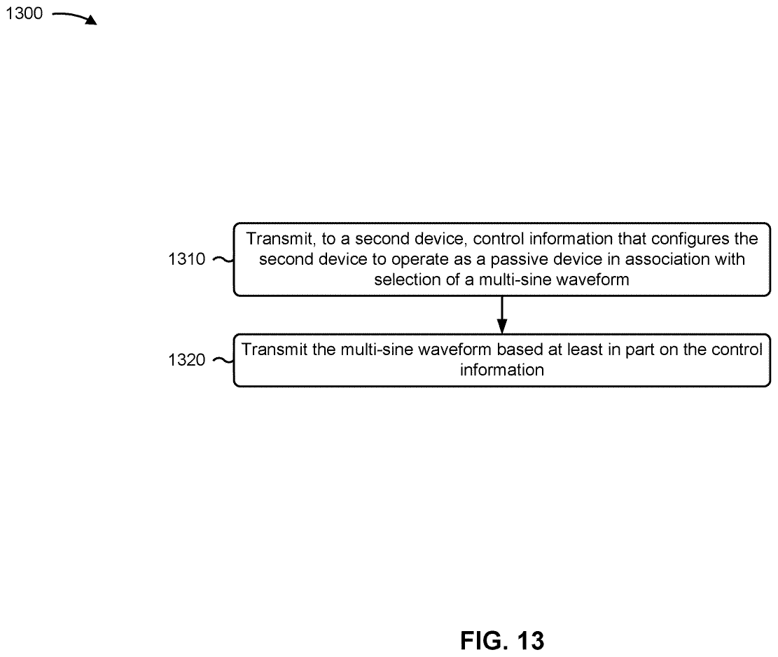

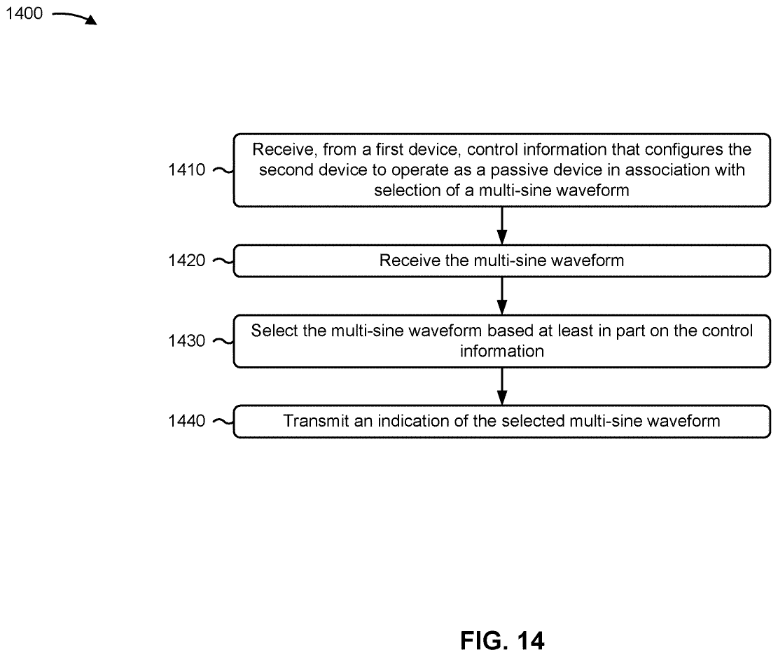

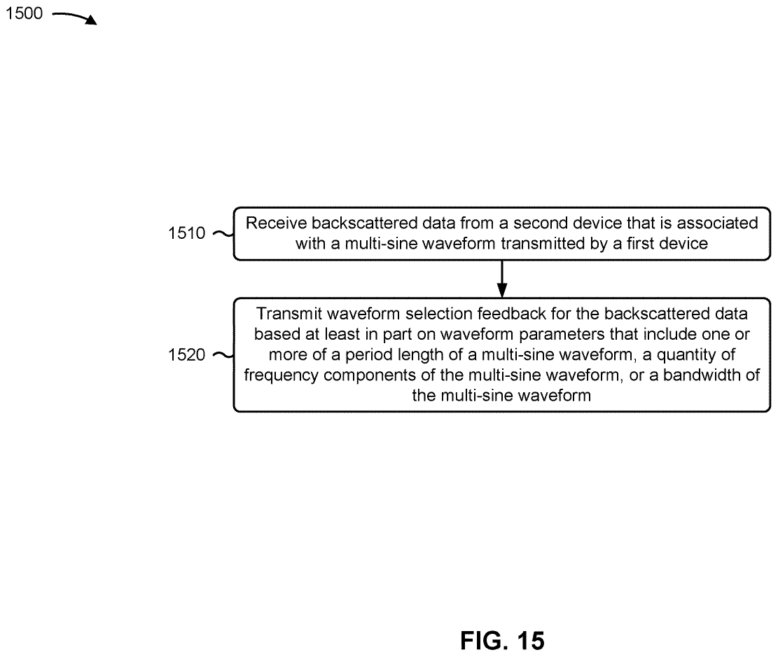

A controller/processor of a network entity, (e.g., the controller/processor 240 of the base station 110), the controller/processor 280 of the UE 120, and/or any other component(s) of FIG. 2 may perform one or more techniques associated with using a multi-sine waveform for a passive device, as described in more detail elsewhere herein. In some aspects, the first device described herein is the UE 120, is included in the UE 120, or includes one or more components of the UE 120 shown in FIG. 2. In some aspects, the second device described herein is the UE 120 or the network entity, is included in the UE 120 or the network entity, or includes one or more components of the UE 120 or the base station 110 shown in FIG. 2. For example, the controller/processor 240 of the base station 110, the controller/processor 280 of the UE 120, and/or any other component(s) of FIG. 2 may perform or direct operations of, for example, process 1300 of FIG. 13, process 1400 of FIG. 14, process 1500 of FIG. 15, and/or other processes as described herein. The memory 242 and the memory 282 may store data and program codes for the network entity and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network entity and/or the UE 120, may cause the one or more processors, the UE 120, and/or the network entity to perform or direct operations of, for example, process 1300 of FIG. 13, process 1400 of FIG. 14, process 1500 of FIG. 15, and/or other processes as described herein. In some examples, executing instructions may include running the instructions, converting the instructions, compiling the instructions, and/or interpreting the instructions, among other examples.

In some aspects, a first device (e.g., UE 120, base station 110) includes means for transmitting, to a second device, control information that configures the second device to operate as a passive device in association with selection of a multi-sine waveform; and/or means for transmitting the multi-sine waveform based at least in part on the control information. In some aspects, the means for the first device to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the first device to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a second device (e.g., an IoT device, a passive UE, a tag, a zero power device, a UE 120, an energy harvesting device) includes means for receiving, from a first device, control information that configures the second device to operate as a passive device in association with selection of a multi-sine waveform; means for receiving the multi-sine waveform; means for selecting the multi-sine waveform based at least in part on the control information; and/or means for transmitting an indication of the selected multi-sine waveform. In some aspects, the means for the second device to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a third device (e.g., UE 120, base station 110) includes means for receiving backscattered data from a second device that is associated with a multi-sine waveform transmitted by a first device; and/or means for transmitting waveform selection feedback for the backscattered data based at least in part on waveform parameters that include one or more of a period length of the multi-sine waveform, a quantity of frequency components of the multi-sine waveform, or a bandwidth of the multi-sine waveform. In some aspects, the means for the third device to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the third device to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

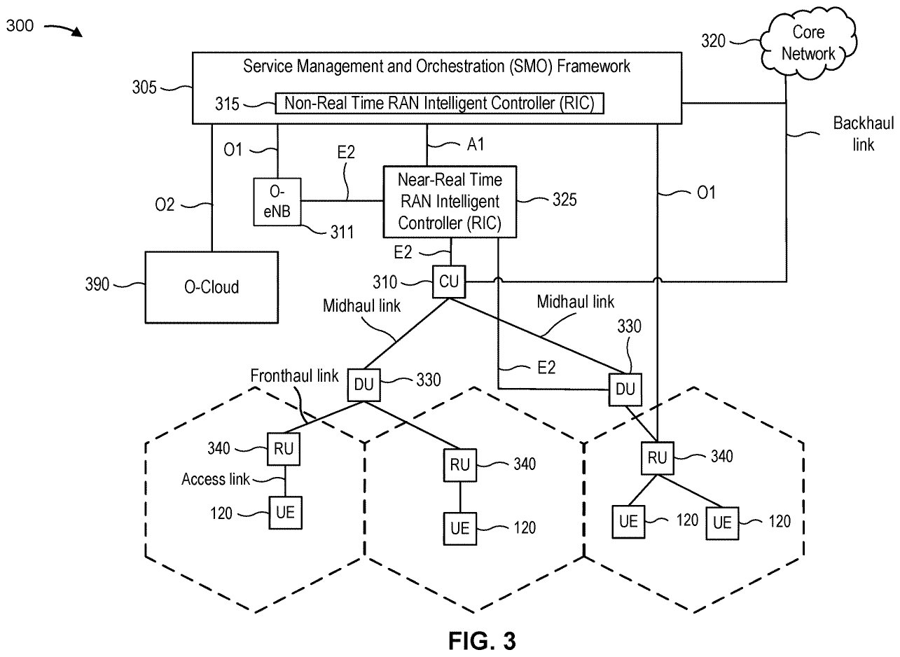

FIG. 3 is a diagram illustrating an example of a disaggregated base station 300, in accordance with the present disclosure.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station 300 architecture may include one or more CUs 310 that can communicate directly with a core network 320 via a backhaul link, or indirectly with the core network 320 through one or more disaggregated base station units (such as a Near-Real Time (Near-RT) RIC 325 via an E2 link, or a Non-Real Time (Non-RT) RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The fronthaul link, the midhaul link, and the backhaul link may be generally referred to as “communication links.” The RUs 340 may communicate with respective UEs 120 via one or more radio frequency (RF) access links. In some aspects, the UE 120 may be simultaneously served by multiple RUs 340. The DUs 330 and the RUs 340 may also be referred to as “O-RAN DUs (O-DUs”) and “O-RAN RUs (O-RUs)”, respectively. A network entity may include a CU, a DU, an RU, or any combination of CUs, DUs, and RUs. A network entity may include a disaggregated base station or one or more components of the disaggregated base station, such as a CU, a DU, an RU, or any combination of CUs, DUs, and RUs. A network entity may also include one or more of a TRP, a relay station, a passive device, an intelligent reflective surface (IRS), or other components that may provide a network interface for or serve a UE, mobile station, sensor/actuator, or other wireless device.

Each of the units, i.e., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

FIG. 4 is a diagram illustrating an example 400 of energy harvesting, in accordance with the present disclosure.

Energy harvesting includes a device obtaining energy from a source other than an on-device battery. This may include obtaining energy from a source outside of the device. Devices that use energy harvesting may have a small energy storage device or battery (e.g., smart watch, RedCap devices, eRedCap devices) or no energy storage device or battery (e.g., zero-power devices, IoT devices, wearables, or financial devices). Energy harvesting may include converting RF energy transferred from another device. The harvesting of RF energy may not fully charge a battery but may be used for some tasks like data decoding, operating some filters, data reception, data encoding, data reception, and/or data transmission. The energy may be accumulated over time. Energy harvesting may also be a part of self-sustainable networks, where a node in the network can interact in the network through the energy harvested in the network through transmissions.

As shown in FIG. 4, an RF receiver (e.g., a UE 120) may receive signals (e.g., radio signals carried on radio waves) from an RF transmitter (e.g., a base station 110 or UE 120) and convert electromagnetic energy of the signals (e.g., using a rectenna comprising a dipole antenna with an RF diode) into direct current electricity for use by the RF receiver. The RF receiver may be a low-power device or a zero-power device. The RF transmitter may be referred to as a “charging device.”

As shown by reference number 405, in some aspects, the RF receiver may use a separated receiver architecture, where a first set of antennas is configured to harvest energy, and a second set of antennas is configured to receive data. In this scenario, each set of antennas may be separately configured to receive signals at certain times, frequencies, and/or via one or more particular beams, such that all signals received by the first set of antennas are harvested for energy, and all signals received by the second set of antennas are processed to receive information.

As shown by reference number 410, in some aspects, the RF receiver may use a time-switching architecture to harvest energy. The time switching architecture may use one or more antennas to receive signals, and whether the signals are harvested for energy or processed to receive information depends on the time at which the signals are received. For example, one or more first time slots may be time slots during which received signals are sent to one or more energy harvesting components to harvest energy, and one or more second time slots may be time slots during which received signals are processed and decoded to receive information. In some aspects, the time slots may be pre-configured (e.g., by the RF receiver, the RF transmitter, or another device).

As shown by reference number 415, in some aspects, the RF receiver may use a power splitting architecture to harvest energy. The power splitting architecture may use one or more antennas to receive signals, and the signals are handled by one or both of the energy harvesting and/or information receiving components according to an energy harvesting rate. For example, the RF receiver may be configured to use a first portion of received signals for energy harvesting and the remaining received signals for information receiving. The energy harvesting mode for a device may be semi-statistically configured by RRC messaging. In some aspects, the energy harvesting rate may be pre-configured (e.g., by the RF receiver, the RF transmitter, or another device). Communications with a network entity may be required, even in the energy harvesting mode, but with a reduced radio capability to reduce power consumption.

The RF receiver may receive signals for energy harvesting on certain resources (e.g., time, frequency, and/or spatial resources) and at a certain power level that results in a particular charging rate. Energy harvested by the RF receiver may be used and/or stored for later use. For example, in some aspects, the RF receiver may be powered directly by the harvested energy. In some aspects, the RF receiver may use an energy storage device, such as a battery, capacitor, and/or supercapacitor, to gather and store harvested energy for immediate and/or later use.

The energy harvesting device may have a low-power or wake-up radio that is configured to detect a low-power wake up signal (WUS) but not perform other communications. The energy harvesting device may have a main radio that is configured to perform communications and that consumes more power than the low-power radio or wake-up radio. The energy harvesting device may have limited RF capabilities (less than enhanced UE) or full RF capabilities (comparable to enhanced UE).

Energy harvesting devices, more generally, may rely equally or differently on different energy harvesting techniques such as solar power, vibration, thermal energy, or RF energy harvesting. Energy harvesting can be predictable or unpredictable due to the energy being intermittently available. Current communications use fixed activity cycles for transmission and reception, such as an on duration of an active discontinuous reception (DRX) cycle. The active DRX cycle may include a part of the DRX cycle when a DRX on-duration timer (time UE is monitoring for physical downlink control channel (PDCCH) communications) or a DRX inactivity timer (time UE is active after successfully decoding a PDCCH communication) is running. A timer may run once it is started, until it is stopped or until it expires; otherwise it is not running. A timer may start if it is not running or restarted if it is running. A timer may be started or restarted from its initial value.

As indicated above, FIG. 4 is provided as an example. Other examples may differ from what is described with regard to FIG. 4.

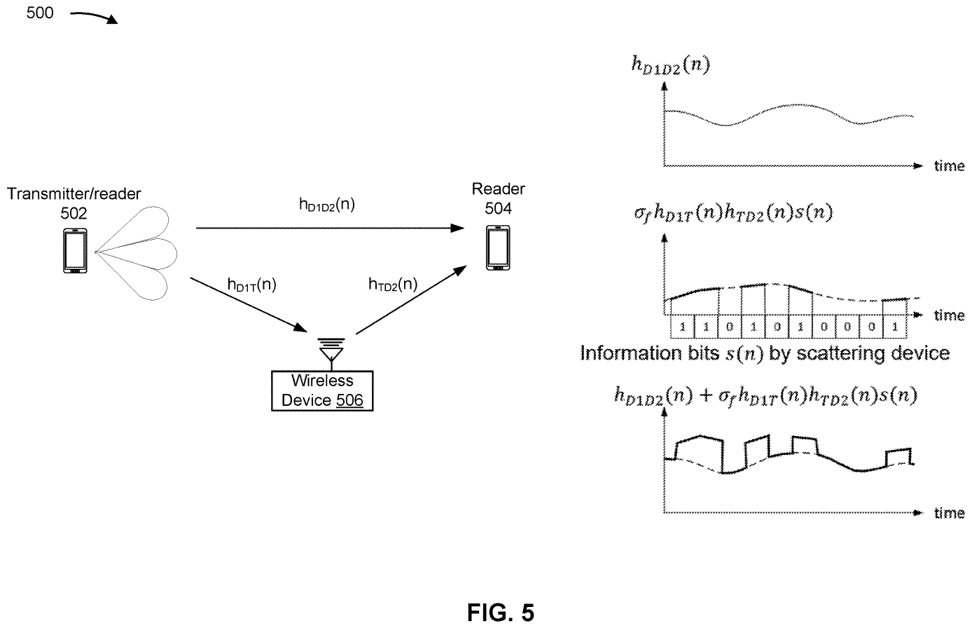

FIG. 5 is a diagram illustrating an example 500 of backscatter communication, in accordance with the present disclosure.

Energy harvesting (EH) devices may include ambient IoT devices (e.g., RF identification (RFID) tags) that rely on passive communication technologies, such as backscatter communication. A ambient IoT device may also be referred to as a “passive UE,” “ambient IoT,” “ambient backscatter device,” or “backscatter device.” Backscatter communication involves using an RF signal to write or transmit data without a battery or a power source. A transmitter/reader 502 may be an RF source that transmits a continuous wave (CW) signal (radio wave denoted as x(n)) that may be received by multiple devices, such as a reader 504. A wireless device 506 (e.g., a ambient IoT device, a passive UE, a UE 120 without energy source, a backscattering device) may harvest energy (e.g., tens or hundreds of microwatts of electricity) from the signal. The wireless device 506 may use passive reflection and modulation of the signal to transmit a backscatter signal using the harvested energy. That is, the wireless device 506 may modulate the signal to encode data and then reflect a fraction of the wave to the reader 504 or to the transmitter/reader 502. The backscatter signal may be encoded with information bits (e.g., identifying information, sensor information) of the wireless device 506. The reader 504 may receive the backscatter signal and read the information bits. In some scenarios, the wireless device 506 may use information commands (e.g., write, transmit) or bits (e.g., data, configuration, indications) modulated in a received data or control signal to write commands or bits to the wireless device 506 itself.

One modulation method for backscattering includes amplitude shift keying (ASK), which switches on the reflection when transmitting information bit “1” and switches off the reflection when transmitting information bit “0”. If the information bits of a backscatter device are s(n)∈{0,1}, the received signal at a UE may be y(n)=(h_{D1D2}(n)+σ_{f}h_{D1T}(n)h_{TD2}(n)s(n))x(n)+noise. In example 500, D1 is the transmitter/reader 502, D2 is the reader 504, and T is the wireless device 506 for transmitted signal h. When s(n)=0, reflection is switched off at the wireless device 506 such that the reader 504 only receives a direct link signal (y(n)=h_{D1D2}(n)x(n)+noise). When s(n)=1, reflection is switched on at the wireless device 506 such that the reader 504 receives the superposition of both the direct link signal and the backscatter, which is represented as y(n)=(h_{D1D2}(n)+σ_{f}h_{D1T}(n)h_{TD2}(n)s(n))x(n)+noise, where σ_{f} denotes the reflection coefficient.

To receive the transmitted information bits by the wireless device 506, the reader 504 may first decode x(n) based on the known h_{D1D2}(n), by treating the backscatter link signal as interference. The reader 504 may then detect the existence of the term σ_{f}h_{D1T}(n)h_{TD2}(n)s(n)x(n) by subtracting h_{D1D2}(n)x(n) from y(n).

There is a tradeoff between harvested energy at a passive UE (e.g., the wireless device 506) and a received signal-to-noise ratio (SNR) at a reader (e.g., the reader 504). The harvested energy at the passive UE is a function of a first channel between the RF source and the passive UE, and the SNR at the reader is a function of both the first channel and a second channel between the passive UE and the reader. Due to the difference between the first channel and the second channel and the energy harvester nonlinearity, the optimal transmit waveform design for SNR and the optimal transmit waveform design for energy maximization are different.

For example, an increase in the quantity of frequency components N of a multi-sine waveform (waveform with multiple sine waves) results in an enlarged SNR-energy region. By increasing N, the waveform exploits the nonlinearity of the rectifier and a frequency diversity gain, the latter being beneficial to both SNR and energy harvesting. The shape of the SNR-energy region highly depends on the channel realizations and the bandwidth. A 1 MHz bandwidth favors higher harvested energy at the passive UE side, while a 10 MHz bandwidth favors a higher SNR at the reader side. Increasing bandwidth B or increasing the quantity of frequency components N may lead to the consumption of more signaling resources or overhead.

Some algorithms for a passive UE network may consider only one passive UE, where 1 bit is backscattered for each time slot, a fixed data rate, and perfect channel state information (CSI) at the transmitter (CSIT). Such algorithms do not consider a scenario with massive passive UEs, where it is not possible to transmit a dedicated (different or optimal) waveform to each passive UE. However, different multi-sine waveforms may lead to different amounts of energy harvested at the passive UE and different SNRs at the reader.

According to various aspects described herein, a passive UE may select a multi-sine waveform from a multi-sine waveform sweeping scheme. For example, an RF source may transmit multiple multi-sine waveforms in the time domain and/or the frequency domain. The passive UE may receive multi-sine waveforms and select a multi-sine waveform based at least in part on control information (e.g., an index indicating a multi-sine waveform, a time domain backscattering occasion, and/or a frequency domain backscattering occasion). The passive UE may backscatter data in a signal received from the RF source. The passive UE may indicate the selected multi-sine waveform to the reader (e.g., including information or an identifier in backscattered data). The reader may receive backscattered data and provide waveform selection feedback to the RF source based at least in part on detection of the multi-sine waveform using waveform parameters (e.g., a period length of the multi-sine waveform, a quantity of frequency components of the multi-sine waveform, a bandwidth of the multi-sine waveform, an integer multiple of a subcarrier spacing). The waveform parameters may include an indication of an equal spacing of sine waves in the multi-sine waveform or of an unequal spacing of sine waves (e.g., between two or more sine waves) in the multi-sine waveform. The waveform parameters may include an indication of equal amplitudes of sine waves in the multi-sine waveform or of unequal amplitudes of sine waves (e.g., between two or more sine waves) in the multi-sine waveform.

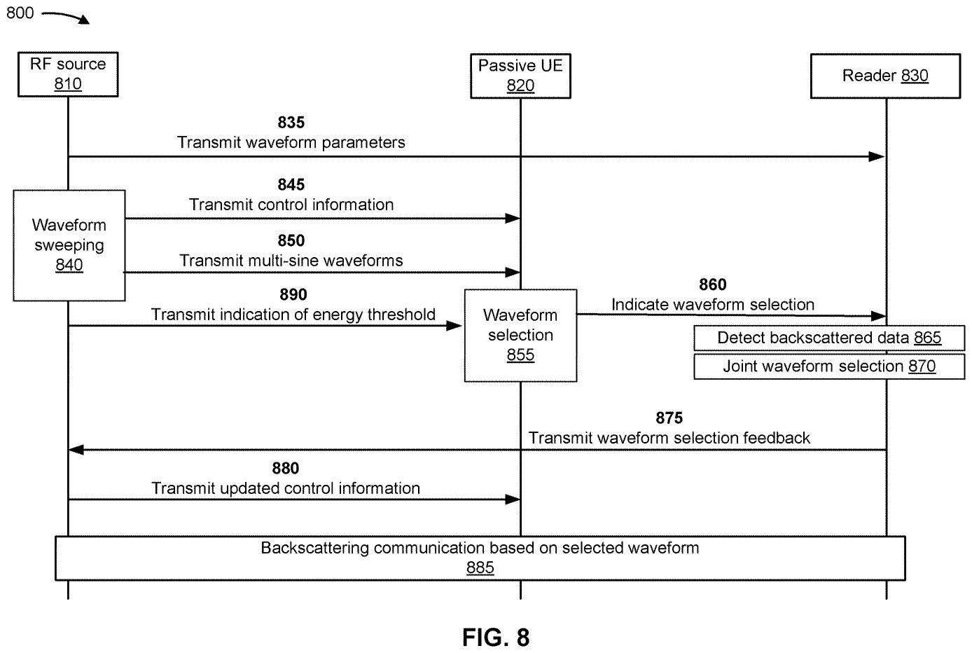

There may be various scenarios that use the control information and the waveform parameters. If the RF source is a network entity, the RF source may transmit the waveform parameters to the reader if the reader is a UE. If the RF source is a UE and the reader is a network entity, the RF source may receive the waveform parameters. The RF source may also be the reader, whether the RF source is a UE or a network entity. The reader may be a UE that is different than an RF source that is a UE, and the RF source and the reader may receive control information and/or waveform parameters from a network entity. FIGS. 8-10 further show some of these scenarios.

By transmitting multiple multi-sine waveforms in a sweeping scheme (time domain and/or frequency domain), the passive UE may select a preferred multi-sine waveform for backscatter communications. As a result, the passive UE may have an opportunity to harvest more energy than if a single multi-sine waveform is applied for the passive UE and the reader. The reader may provide waveform selection feedback to the RF source, and the RF source may be able to adjust the selection of the multi-sine waveform to also optimize the SNR at the reader. Improved energy harvesting extends functionality, and improved SNR improves communications (which conserves time, power, processing resources, and signaling resources). The multi-sine waveform selection may also not expect to assume that there is perfect CSIT.

As indicated above, FIG. 5 is provided as an example. Other examples may differ from what is described with regard to FIG. 5.

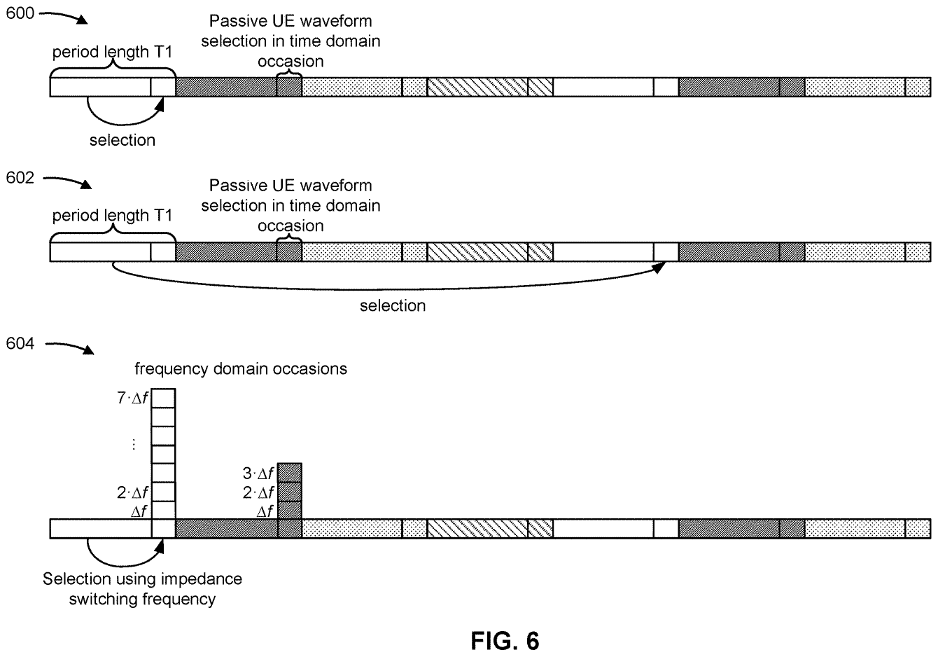

FIG. 6 is a diagram illustrating examples 600, 602, and 604 of backscattering occasions, in accordance with the present disclosure.

Examples 600, 602, and 604 each show multi-sine waveforms that are transmitted in a sweeping scheme in the time domain. Each transmission period, shown in examples 600, 602, and 604, for a multi-sine waveform may have a bandwidth B and a period length T, such as period length T1 for the first transmission period. The period length may be different for a different quantity N of frequency components of the multi-sine waveform. A passive UE may select a multi-sine waveform in a backscattering occasion within a same transmission period or a different transmission period. The backscattering occasion may be a time domain backscattering occasion, a frequency domain backscattering occasion, or a combination thereof. Each transmission period may have a specific configuration of the waveform parameter values of N, B, and/or T. The RF source and/or the reader may receive an indication of the waveform parameter values of N, B, and/or T from the network entity.

Examples 600 and 602 show transmission periods with time domain backscattering occasions for a passive UE to select a multi-sine waveform. The passive UE may indicate its selections in one or more time domain occasions associated with multi-sine waveforms with one or more waveform parameters (e.g., N, B, T) that are configured. Example 600 shows that each time domain occasion associated with the multi-sine waveform selection is in the same transmission period. Example 602 shows that the time domain occasion associated with the multi-sine waveform is in a different period.

Example 604 shows that there may be different frequency domain backscattering occasions. The RF source may indicate one or more frequency domain backscattering occasions to the passive UE for waveform selection. The indicated frequency domain occasion may be associated with an impedance switching frequency, which may be a multiple of a subcarrier spacing (SCS), such as f_{b}=n·Δf, where Δf is based at least in part on the SCS, and where the range of n may be based at least in part on the quantity of resource elements (REs) between different frequency components in the multi-sine waveform. That is, the range of n may be based at least in part on the values for Δf, N and B. The passive UE may use the indicated time domain backscattering occasion and the indicated frequency domain backscattering occasion with a random n in the indicated range for waveform selection.

As indicated above, FIG. 6 is provided as an example. Other examples may differ from what is described with regard to FIG. 6.

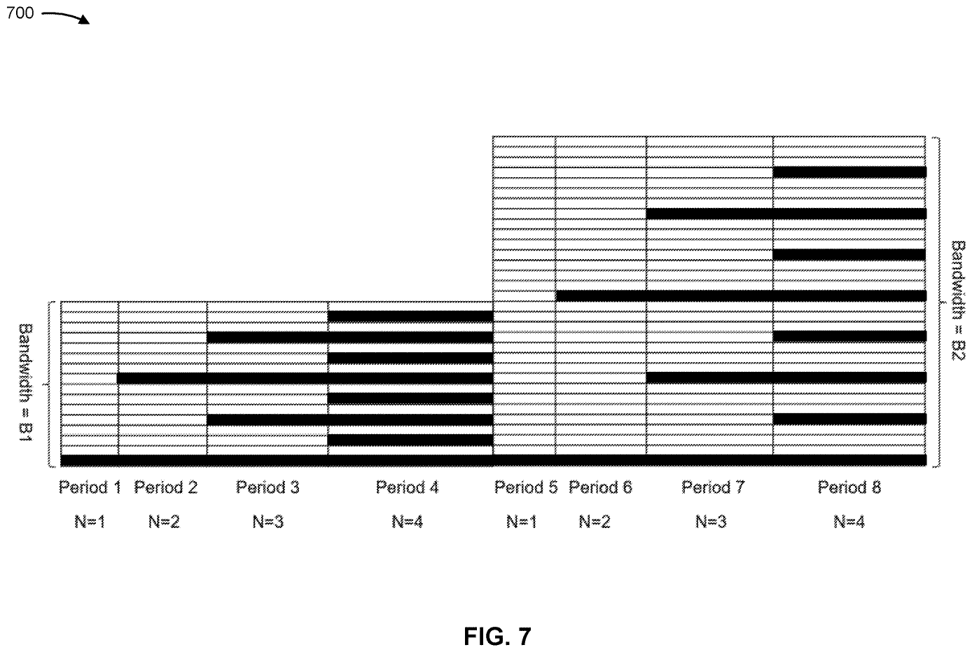

FIG. 7 is a diagram illustrating an example 700 of a multi-sine waveform sweeping scheme, in accordance with the present disclosure.

In some aspects, a transmitted multi-sine waveform may be represented as:

$$x ( t ) = {\sum }_{n = 0}^{N - 1} {ω}_{n} exp ( j \cdot 2 π {f}_{n} t ) , where {f}_{n} = {f}_{0} + n \cdot \frac{B}{N} and {ω}_{n} = {s}_{n} exp ( j \cdot {θ}_{n} ) ,$$

fₙ is the frequency of the n-th sine wave and ωₙ=sₙ exp(j·θₙ), where sₙ and θₙ is the amplitude and phase of the n-th sine wave. When N=1, the waveform falls back to a single sine waveform. Equal frequency spacing is considered in this example.

Example 700 shows the frequencies used for different transmission periods with different values for B and N. The dark portions in example 700 represent the location of the frequency components of the multi-sine waveform in each transmission period.

In some aspects, associated with equal frequency spacing,

$${f}_{n} = {f}_{0} + n \cdot \frac{B}{N} .$$

This option is beneficial in a scenario where there is a dedicated bandwidth B for the ambient IoT network and there is no NR legacy data transmitted in this bandwidth B. Here, n may range from 1 to [B/Δf/N]−1, or at most [B/Δf/N]−1 passive UEs could be multiplexed using frequency shift keying (FSK) in the same multi-sine waveform transmitted in a first channel between the RF source and the passive UE.

Alternatively, in some aspects associated with unequal frequency spacing, fₙ may be in any frequency tones ranging from f₀ to f₀+B with an SCS Δf, if multiplexing with the legacy NR OFDM systems. This option is beneficial in a scenario where both the ambient IoT network and the NR legacy network, such as shown in FIG. 1, share the bandwidth B. Some frequency division multiplexing (FDM) interference avoidance schemes (or joint scheduling schemes) may be applied by using unequal frequency spacing. Note that not all spacing may be unequal.

In some aspects, the amplitudes may be equal for different frequency components, and

$${\vert {s}_{n} \vert}^{2} = \frac{P}{N} ,$$

where P may be a transmission power. Alternatively, in some aspects, amplitudes may be unequal (some or all), and

$${\sum }_{n = 0}^{N - 1} {\vert {s}_{n} \vert}^{2} = P .$$

θₙ may be adjusted together with the NR legacy data to satisfy certain peak to average power (PARP) requirements.

In some aspects, the RF source or the reader may transmit (e.g., if network entity) or receive (e.g., if a UE) a first indication of one or more of a period length T of the multi-sine waveform, a quantity of frequency components N of the multi-sine waveform, or a bandwidth B of the multi-sine waveform. The RF source or the reader may also transmit a second indication of an equal spacing of sine waves in the multi-sine waveform or an unequal spacing of the sine waves. The RF source or the reader may also receive a second indication of an equal spacing of sine waves in the multi-sine waveform or an unequal spacing of the sine waves. The RF source or the reader may also transmit a second (or third) indication of equal amplitudes of the sine waves or unequal amplitudes of the sine waves. The RF source or the reader may also transmit a second (or third) indication of equal amplitudes of the sine waves or unequal amplitudes of the sine waves.

As indicated above, FIG. 7 is provided as an example. Other examples may differ from what is described with regard to FIG. 7.

FIG. 8 is a diagram illustrating an example 800 associated with multi-sine waveform selection, in accordance with the present disclosure. As shown in FIG. 8, an RF source 810 (e.g., a UE 120 or a network entity) may transmit RF energy to a passive UE 820 (e.g., an RFID tag, an IoT device, an EH device, a zero power device, or a UE 120) for backscattering. The passive UE 820 may not have its own power source and may require EH for operational power. The passive UE 820 may backscatter data that is detected by a reader 830 (e.g., a UE 120 or a network entity).

Example 800 shows multi-sine waveform selection when the RF source is a network entity. As shown by reference number 835, the RF source 810 may transmit waveform parameters. The waveform parameters may include N, B, T, or any combination thereof. The waveform parameters may include an indication of equal or unequal frequency spacing. The waveform parameters may include an indication of equal/unequal amplitudes. As shown by reference number 840, the RF source 810 may perform multi-sine waveform sweeping, which may include transmitting different multi-sine waveforms in different transmission periods and/or in different frequencies. As shown by reference number 845, the RF source 810 may transmit control information (e.g., a waveform index, a time domain backscattering occasion, a frequency domain backscattering occasion). As shown by reference number 850, the RF source may transmit multi-sine waveforms as part of the waveform sweeping.

As shown by reference number 855, the passive UE 820 may receive the multi-sine waveforms and select a multi-sine waveform based at least in part on the control information. That is, the passive UE 820 may select the multi-sine waveform based at least in part on a waveform index, a time domain backscattering occasion, and/or a frequency domain backscattering occasion.

As shown by reference number 860, the passive UE 820 may indicate the waveform selection. This may include adding an identifier (ID) of the passive UE 820 or other information into backscattered data. The reader 830 may detect the ID of the passive UE 820 or the information in the backscattered data, as shown by reference number 865.

As shown by reference number 875, the reader 830 may transmit waveform selection feedback to the RF source 810. The waveform selection feedback may include a waveform index and/or a passive UE ID. The waveform selection feedback may indicate whether a multi-sine waveform selected by the passive UE 820 has a sufficient SNR (e.g., satisfies an SNR threshold) or whether a particular multi-sine waveform for the passive UE 820 may be preferred. As shown by reference number 880, the RF source 810 may transmit updated control information based at least in part on the waveform selection feedback. As shown by reference number 885, the RF source 810, the passive UE 820, and the reader 830 may perform backscattering communication based at least in part on the selected multi-sine waveform.

In some aspects, the RF source 810 and the reader 830 may be the same network entity. In such a scenario, the waveform parameters and the waveform selection feedback are not transmitted.

As indicated above, FIG. 8 is provided as an example. Other examples may differ from what is described with regard to FIG. 8.

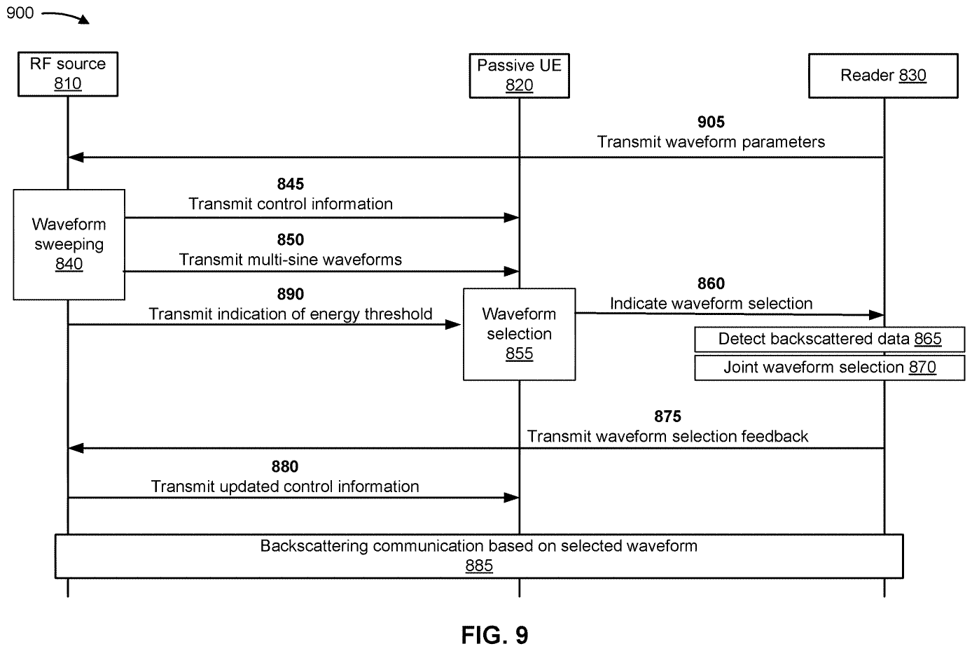

FIG. 9 is a diagram illustrating an example 900 associated with multi-sine waveform selection, in accordance with the present disclosure.

Example 900 shows multi-sine waveform selection when the RF source 810 is a UE. As shown by reference number 905, the reader 830 may be a network entity (or another UE) and may transmit the waveform parameters to the RF source 810. The waveform parameters may include N, B, T, or any combination thereof. The waveform parameters may include an indication of equal or unequal frequency spacing. The waveform parameters may include an indication of equal/unequal amplitudes. The other steps may proceed as described in connection with FIG. 8. In some aspects, the RF source 810 and the reader 830 may be the same UE. In such a scenario, the waveform parameters and the waveform selection feedback are not transmitted.

As indicated above, FIG. 9 is provided as an example. Other examples may differ from what is described with regard to FIG. 9.

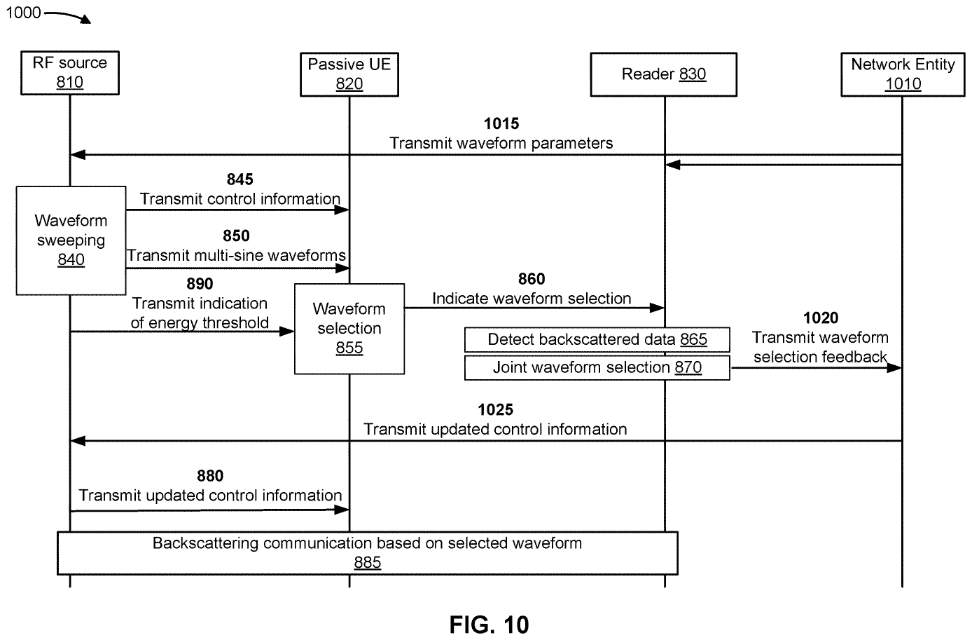

FIG. 10 is a diagram illustrating an example 1000 associated with multi-sine waveform selection, in accordance with the present disclosure.

Example 1000 shows multi-sine waveform selection when a network entity 1010 (e.g., base station 110) provides the waveform parameters and helps to determine the control information. The reader 830 may be another UE. As shown by reference number 1015, the network entity 1010 may transmit the waveform parameters. The other steps may proceed as described in connection with FIGS. 8 and 9, except that the reader 830 may transmit the waveform selection feedback to the network entity 1010, as shown by reference number 1020. As shown by reference number 1025, the network entity 1010 may transmit updated control information, which may include a waveform index and/or a passive UE ID for waveform selection. The RF source 810 may transmit updated control information to the passive UE 820 based at least in part on the updated control information received from the network entity 1010. The network entity 1010 may also transmit waveform selection feedback to the RF source 810.

As indicated above, FIG. 10 is provided as an example. Other examples may differ from what is described with regard to FIG. 10.

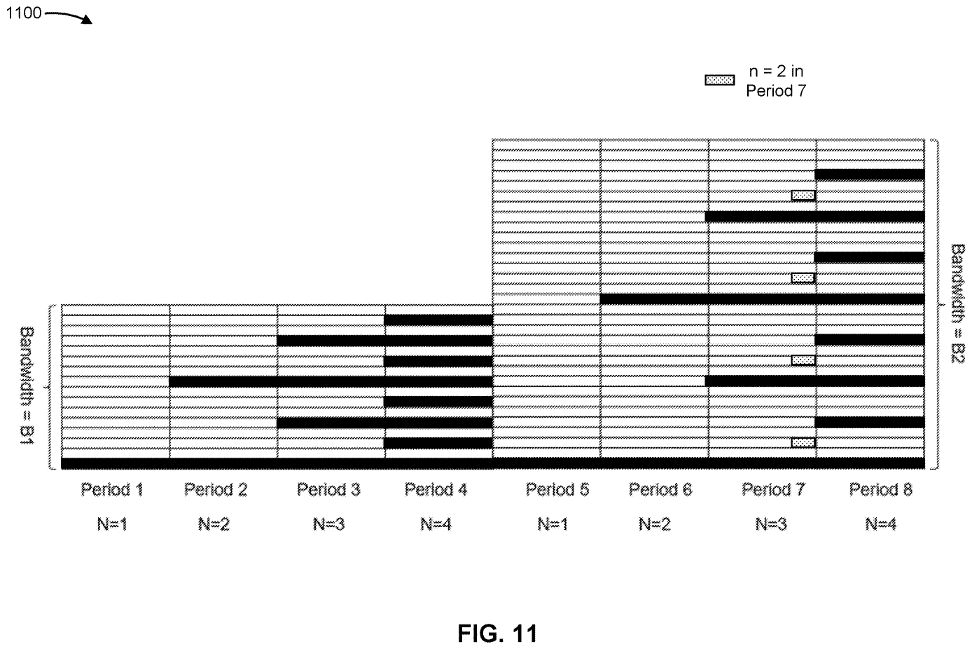

FIG. 11 is a diagram illustrating an example 1100 of waveform selection, in accordance with the present disclosure.

In some aspects, the passive UE 820 may select the multi-sine waveform based at least in part on an energy state of the passive UE 820. The energy state may include a current energy status (e.g., amount of energy) and/or an amount of power that is obtained through energy harvesting. The energy status may account for a future estimated energy state based on energy harvesting conditions, an energy harvesting efficiency, channel conditions, traffic conditions, or one or more capabilities of the passive UE 820. When the harvested energy or the energy harvesting efficiency exceeds a threshold (e.g., energy threshold), the passive UE 820 may select the waveform transmitted in the current period by backscattering its passive UE ID in the indicated time domain backscattering occasion and/or frequency domain backscattering occasion. The RF source 810 may indicate the threshold to the passive UE 820 or the threshold may be specified in stored configuration information. As shown by reference number 890, the RF source may transmit an indication of an energy threshold.

The RF source 810 may indicate the range of n to the passive UE 820. The passive UE 820 may select a random n in the range to switch its impedance at frequency f_{b}=n·Δf. Note that the waveform in the backscattering link is also multi-sine waveform. Due to the non-linearity of the rectifier, the quantity of frequency components N may affect the harvested energy or the energy harvesting efficiency. The rectifier may operate based at least in part on a Taylor series expansion of the diode characteristic equation:

$${i}_{d} ( t ) = {i}_{s} ( exp ( \frac{{v}_{d} ( t )}{{n v}_{t}} ) - 1 )$$

with iₛ being the reverse bias saturation current, vₜ being the thermal voltage, and n being the ideality factor equal to 1.05, for example.

Example 1100 shows that the passive UE 820 may select n=2, where f_{b}=2. Δf, in Period 7 for the multi-sine waveform selection in that period.

As indicated above, FIG. 11 is provided as an example. Other examples may differ from what is described with regard to FIG. 11.

In some aspects, the passive UE 820 and the reader 830 may jointly determine a waveform selection scheme. When the reader 830 receives the signal backscattered from multiple passive UEs in a same time domain backscattering occasion but different frequency domain backscattering occasions, the reader 830 may indicate, as feedback, one or more of the following to the RF source 810 (e.g., through a network entity if appropriate) for the backscattering data transmission: (i) a received SNR associated with a passive UE ID and waveform index; (ii) a recommended modulation order associated with a passive UE ID and a waveform index; (iii) a recommended coding rate associated with a passive UE ID and a waveform index; or (iv) other parameters associated with an MCS.

In some aspects, when the reader 830 does not receive the signal backscattered from a passive UE with its selected multi-sine waveform, the RF source 810 may not receive the feedback associated with the passive UE ID from the reader 830, which implicitly indicates a current waveform selection failure at the passive UE side. The passive UE 820 may select the multi-sine waveform that satisfies the harvested energy or the energy harvesting efficiency in the first channel until the passive UE 820 receives a waveform assignment from the RF source 810.

In some aspects, the waveform selection by the passive UE 820 may be part of a two-step joint waveform selection scheme, as shown by reference numbers 855 and 870 in FIG. 8). The passive UE 820, when the harvested energy or the energy harvesting efficiency satisfies a threshold, may select the waveform transmitted in the current period by backscattering its UE ID in the indicated time domain backscattering occasion and frequency domain backscattering occasion. This may be a first step.

As a second step, the reader 830 may receive the signal backscattered from multiple passive UEs in the same time domain backscattering occasion but different frequency domain backscattering occasions. In some aspects, when the transmission of the passive UE ID is encoded using an orthogonal sequence, then the received passive UE ID may exceed the total allowed maximum quantity of UEs that can be frequency division multiplexed using different impedance switching frequencies (e.g., f_{b}=n·Δf). The reader 820 may provide waveform selection feedback to the RF source 810 associated with the passive UE ID with a larger SNR.

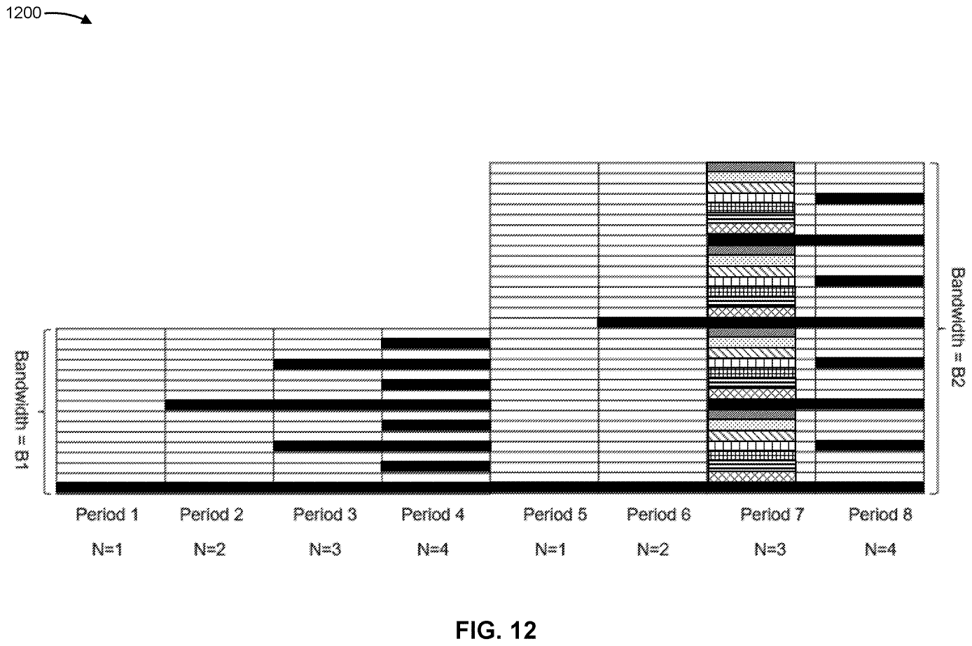

FIG. 12 is a diagram illustrating an example 1200 of group backscattering, in accordance with the present disclosure.

In some aspects, the RF source 810 may group passive UEs that select the same multi-sine waveform for group backscattering data transmission. Each passive UE may be assigned a different impedance switching frequency (e.g., f_{b}=n·Δf). The indicated impedance switching frequency may be different from the one that is randomly selected by the passive UE 820 for waveform selection.

Example 1200 shows group backscattering data transmission in Period 7. Each different pattern represents a different passive UE backscattering data transmission. The waveform backscattered from each passive UE may still be a multi-sine waveform with the same frequency component transmitted from the RF source 810.

As indicated above, FIG. 12 is provided as an example. Other examples may differ from what is described with regard to FIG. 12.

FIG. 13 is a diagram illustrating an example process 1300 performed, for example, by a first device, in accordance with the present disclosure. Example process 1300 is an example where the first device (e.g., UE 120, network entity, RF source 810) performs operations associated with using a multi-sine waveform for a passive device.

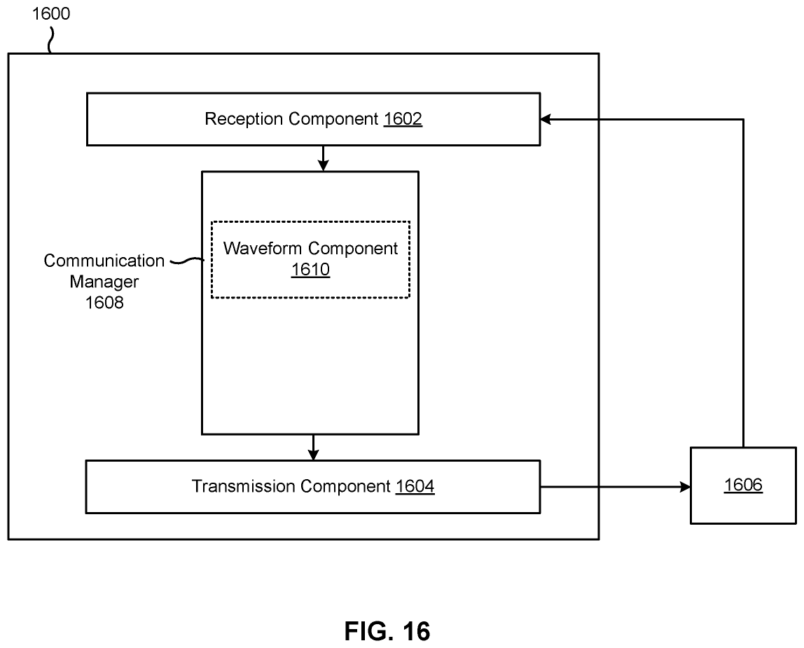

As shown in FIG. 13, in some aspects, process 1300 may include transmitting, to a second device, control information that configures the second device to operate as a passive device in association with selection of a multi-sine waveform (block 1310). For example, the first device (e.g., using communication manager 1608 and/or transmission component 1604 depicted in FIG. 16) may transmit, to a second device, control information that configures the second device to operate as a passive device in association with selection of a multi-sine waveform, as described above.

As further shown in FIG. 13, in some aspects, process 1300 may include transmitting the multi-sine waveform based at least in part on the control information (block 1320). For example, the first device (e.g., using communication manager 1608 and/or transmission component 1604 depicted in FIG. 16) may transmit the multi-sine waveform based at least in part on the control information, as described above.

Process 1300 may include additional aspects, such as any single aspect or any combination of aspects described below and/or in connection with one or more other processes described elsewhere herein.

In a first aspect, the control information indicates an index of the multi-sine waveform.

In a second aspect, alone or in combination with the first aspect, the control information indicates one or more of a time domain backscattering occasion for selecting the multi-sine waveform or a frequency domain backscattering occasion for selecting the multi-sine waveform.

In a third aspect, alone or in combination with one or more of the first and second aspects, the frequency domain backscattering occasion is based at least in part on an impedance switching frequency.

In a fourth aspect, alone or in combination with one or more of the first through third aspects, the frequency domain backscattering occasion is based at least in part on an integer multiple of a subcarrier spacing, and the multiple is based at least in part on a quantity of resource elements between frequency components of the multi-sine waveform.

In a fifth aspect, alone or in combination with one or more of the first through fourth aspects, the first device is a user equipment, and process 1300 includes receiving a first indication of one or more of a period length of the multi-sine waveform, a quantity of frequency components of the multi-sine waveform, or a bandwidth of the multi-sine waveform.

In a sixth aspect, alone or in combination with one or more of the first through fifth aspects, process 1300 includes receiving the control information from a network entity.

In a seventh aspect, alone or in combination with one or more of the first through sixth aspects, the first device is a network entity, and process 1300 includes transmitting a first indication of one or more of a period length of the multi-sine waveform, a quantity of frequency components of the multi-sine waveform, or a bandwidth of the multi-sine waveform.

In an eighth aspect, alone or in combination with one or more of the first through seventh aspects, process 1300 includes transmitting or receiving a second indication of an equal spacing of sine waves in the multi-sine waveform.

In a ninth aspect, alone or in combination with one or more of the first through eighth aspects, process 1300 includes transmitting or receiving a second indication of an unequal spacing of sine waves in the multi-sine waveform.

In a tenth aspect, alone or in combination with one or more of the first through ninth aspects, process 1300 includes transmitting or receiving a second indication of equal amplitudes of sine waves in the multi-sine waveform.

In an eleventh aspect, alone or in combination with one or more of the first through tenth aspects, process 1300 includes transmitting or receiving a second indication of unequal amplitudes of sine waves in the multi-sine waveform.

In a twelfth aspect, alone or in combination with one or more of the first through eleventh aspects, process 1300 includes receiving waveform selection feedback, and transmitting updated control information based at least in part on the waveform selection feedback.

In a thirteenth aspect, alone or in combination with one or more of the first through twelfth aspects, the waveform selection feedback includes one or more of a signal-to-noise ratio associated with an ID of the second device, a recommended modulation order associated with the ID of the second device, a recommended coding rate associated with the ID of the second device, a parameter, or a waveform index.

In a fourteenth aspect, alone or in combination with one or more of the first through thirteenth aspects, process 1300 includes receiving an indication of one or more of a period length of the multi-sine waveform, a quantity of frequency components of the multi-sine waveform, or a bandwidth of the multi-sine waveform.

In a fifteenth aspect, alone or in combination with one or more of the first through fourteenth aspects, process 1300 includes grouping passive devices that select a same multi-sine waveform for group backscattering.

In a sixteenth aspect, alone or in combination with one or more of the first through fifteenth aspects, process 1300 includes receiving, from the second device, backscattered data that is associated with a multi-sine waveform transmitted by the first device.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a second device, in accordance with the present disclosure. Example process 1400 is an example where the second device (e.g., UE 120, tag, IoT device, passive UE 820) performs operations associated with selecting a multi-sine waveform.

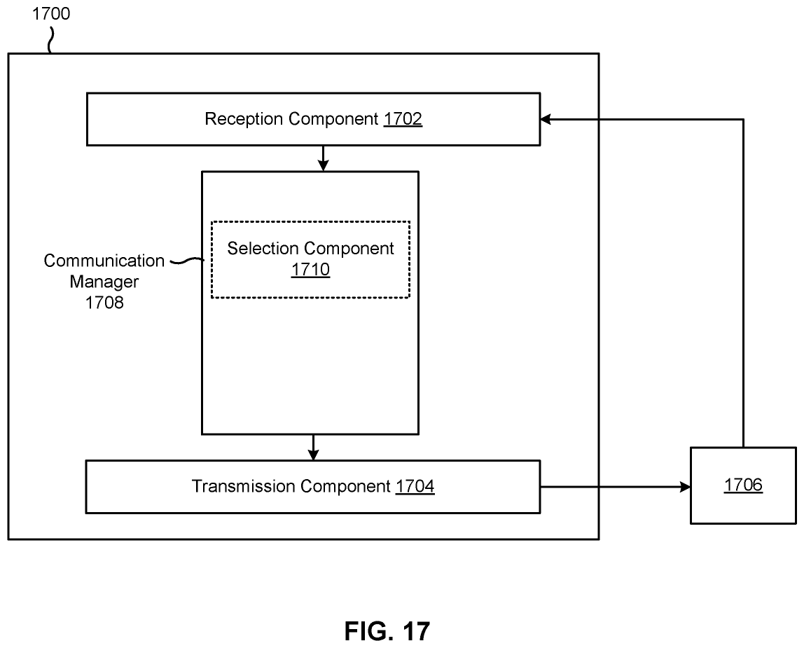

As shown in FIG. 14, in some aspects, process 1400 may include receiving, from a first device, control information that configures the second device to operate as a passive device in association with selection of a multi-sine waveform (block 1410). For example, the second device (e.g., using communication manager 1708 and/or reception component 1702 depicted in FIG. 17) may receive, from a first device, control information that configures the second device to operate as a passive device in association with selection of a multi-sine waveform, as described above.

As further shown in FIG. 14, in some aspects, process 1400 may include receiving the multi-sine waveform (block 1420). For example, the second device (e.g., using communication manager 1708 and/or reception component 1702 depicted in FIG. 17) may receive the multi-sine waveform, as described above.

As further shown in FIG. 14, in some aspects, process 1400 may include selecting the multi-sine waveform based at least in part on the control information (block 1430). For example, the second device (e.g., using communication manager 1708 and/or selection component 1710 depicted in FIG. 17) may select the multi-sine waveform based at least in part on the control information, as described above.

As further shown in FIG. 14, in some aspects, process 1400 may include transmitting an indication of the selected multi-sine waveform (block 1440). For example, the second device (e.g., using communication manager 1708 and/or transmission component 1704 depicted in FIG. 17) may transmit an indication of the selected multi-sine waveform, as described above.

Process 1400 may include additional aspects, such as any single aspect or any combination of aspects described below and/or in connection with one or more other processes described elsewhere herein.

In a first aspect, the control information indicates one or more of an index of the multi-sine waveform, a time domain backscattering occasion for selecting the multi-sine waveform, or a frequency domain backscattering occasion for selecting the multi-sine waveform.

In a second aspect, alone or in combination with the first aspect, the frequency domain backscattering occasion is based at least in part on an impedance switching frequency.

In a third aspect, alone or in combination with one or more of the first and second aspects, the frequency domain backscattering occasion is based at least in part on a multiple of a subcarrier spacing, and the multiple is based at least in part on a quantity of resource elements between frequency components of the multi-sine waveform.

In a fourth aspect, alone or in combination with one or more of the first through third aspects, selecting the multi-sine waveform includes selecting the multi-sine waveform based at least in part on an energy state of the second device.

In a fifth aspect, alone or in combination with one or more of the first through fourth aspects, process 1400 includes backscattering an identifier of the second device based at least in part on the selected multi-sine waveform.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, by a third device, in accordance with the present disclosure. Example process 1500 is an example where the third device (e.g., UE 120, network entity, reader 830) performs operations associated with using a multi-sine waveform for a passive device.

As shown in FIG. 15, in some aspects, process 1500 may include receiving backscattered data from a second device that is associated with a multi-sine waveform transmitted by a first device (block 1510). For example, the third device (e.g., using communication manager 1608 and/or reception component 1602 depicted in FIG. 16) may receive backscattered data from a second device that is associated with a multi-sine waveform transmitted by a first device, as described above.

As further shown in FIG. 15, in some aspects, process 1500 may include transmitting waveform selection feedback for the backscattered data based at least in part on waveform parameters that include one or more of a period length of the multi-sine waveform, a quantity of frequency components of the multi-sine waveform, or a bandwidth of the multi-sine waveform (block 1520). For example, the third device (e.g., using communication manager 1608 and/or transmission component 1604 depicted in FIG. 16) may transmit waveform selection feedback for the backscattered data based at least in part on waveform parameters that include one or more of a period length of the multi-sine waveform, a quantity of frequency components of the multi-sine waveform, or a bandwidth of the multi-sine waveform, as described above.

Process 1500 may include additional aspects, such as any single aspect or any combination of aspects described below and/or in connection with one or more other processes described elsewhere herein.

In a first aspect, the third device is a network entity, and process 1500 includes transmitting the waveform parameters.

In a second aspect, alone or in combination with the first aspect, the third device is a user equipment, and process 1500 includes receiving the waveform parameters.

In a third aspect, alone or in combination with one or more of the first and second aspects, transmitting the waveform selection feedback includes transmitting the waveform selection feedback based at least in part on receiving the backscattered data from multiple passive devices in a same time domain backscattering occasion but in different frequency domain backscattering occasions.

In a fourth aspect, alone or in combination with one or more of the first through third aspects, the waveform selection feedback includes one or more of a signal-to-noise ratio associated with an ID of the second device, a recommended modulation order associated with the ID of the second device, a recommended coding rate associated with the ID of the second device, a parameter, or a waveform index.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram of an example apparatus 1600 for wireless communication, in accordance with the present disclosure. The apparatus 1600 may be an RF source (e.g., UE 120, network entity) or a reader (e.g., UE 120, network entity), or an RF source or a reader may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a base station, network entity, or another wireless communication device) using the reception component 1602 and the transmission component 1604. As further shown, the apparatus 1600 may include the communication manager 1608. The communication manager 1608 may control and/or otherwise manage one or more operations of the reception component 1602 and/or the transmission component 1604. In some aspects, the communication manager 1608 may include one or more antennas, a modem, a controller/processor, a memory, or a combination thereof, of the UE or network entity described in connection with FIG. 2. The communication manager 1608 may be, or be similar to, the communication manager 140 or 150 depicted in FIGS. 1 and 2. For example, in some aspects, the communication manager 1608 may be configured to perform one or more of the functions described as being performed by the communication manager 140 or 150. In some aspects, the communication manager 1608 may include the reception component 1602 and/or the transmission component 1604. The communication manager 1608 may include a waveform component 1610, among other examples.

In some aspects, the apparatus 1600 may be configured to perform one or more operations described herein in connection with FIGS. 1-12. Additionally, or alternatively, the apparatus 1600 may be configured to perform one or more processes described herein, such as process 1300 of FIG. 13, process 1500 of FIG. 15, or a combination thereof. In some aspects, the apparatus 1600 and/or one or more components shown in FIG. 16 may include one or more components of the UE or network entity described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the UE or network entity described in connection with FIG. 2.

The transmission component 1604 may transmit communications, such as reference signals, control information, data communications, or a combination thereof, to the apparatus 1606. In some aspects, one or more other components of the apparatus 1600 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the UE or network entity described in connection with FIG. 2. In some aspects, the transmission component 1604 may be co-located with the reception component 1602 in a transceiver.

The transmission component 1604 may transmit, to a second device, control information that configures the second device to operate as a passive device in association with selection of a multi-sine waveform. The transmission component 1604 may transmit the multi-sine waveform based at least in part on the control information.

The reception component 1602 may receive the control information from a network entity. The transmission component 1604 may transmit or receive a second indication of an equal spacing of sine waves in the multi-sine waveform.

The transmission component 1604 may transmit or receive a second indication of an unequal spacing of sine waves in the multi-sine waveform. The transmission component 1604 may transmit or receive a second indication of equal amplitudes of sine waves in the multi-sine waveform. The transmission component 1604 may transmit or receive a second indication of unequal amplitudes of sine waves in the multi-sine waveform.

The reception component 1602 may receive waveform selection feedback. The transmission component 1604 may transmit updated control information based at least in part on the waveform selection feedback.

The reception component 1602 may receive an indication of one or more of a period length of the multi-sine waveform, a quantity of frequency components of the multi-sine waveform, or a bandwidth of the multi-sine waveform. The waveform component 1610 may group passive devices that select a same multi-sine waveform for group backscattering. The reception component 1602 may receive, from the second device, backscattered data that is associated with a multi-sine waveform transmitted by the first device.

In some aspects, the reception component 1602 may receive backscattered data from a second device that is associated with a multi-sine waveform transmitted by a first device. The transmission component 1604 may transmit waveform selection feedback for the backscattered data based at least in part on waveform parameters that include one or more of a period length of the multi-sine waveform, a quantity of frequency components of the multi-sine waveform, or a bandwidth of the multi-sine waveform.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

FIG. 17 is a diagram of an example apparatus 1700 for wireless communication, in accordance with the present disclosure. The apparatus 1700 may be a passive UE (e.g., UE 120, tag, IoT device, passive UE 820), or a passive UE may include the apparatus 1700. In some aspects, the apparatus 1700 includes a reception component 1702 and a transmission component 1704, which may be in communication with one another (for example, via one or more buses and/or one or more other components). As shown, the apparatus 1700 may communicate with another apparatus 1706 (such as a UE, a base station, or another wireless communication device) using the reception component 1702 and the transmission component 1704. As further shown, the apparatus 1700 may include the communication manager 1708. The communication manager 1708 may control and/or otherwise manage one or more operations of the reception component 1702 and/or the transmission component 1704. In some aspects, the communication manager 1708 may include one or more antennas, a modem, a controller/processor, a memory, or a combination thereof, of the UE described in connection with FIG. 2. The communication manager 1708 may be, or be similar to, the communication manager 140 depicted in FIGS. 1 and 2. For example, in some aspects, the communication manager 1708 may be configured to perform one or more of the functions described as being performed by the communication manager 1708. In some aspects, the communication manager 1708 may include the reception component 1702 and/or the transmission component 1704. The communication manager 1708 may include a selection component 1710, among other examples.

In some aspects, the apparatus 1700 may be configured to perform one or more operations described herein in connection with FIGS. 1-12. Additionally, or alternatively, the apparatus 1700 may be configured to perform one or more processes described herein, such as process 1400 of FIG. 14. In some aspects, the apparatus 1700 and/or one or more components shown in FIG. 17 may include one or more components of the passive UE described in connection with FIG. 2. Additionally, or alternatively, one or more components shown in FIG. 17 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1702 may receive communications, such as reference signals, control information, data communications, or a combination thereof, from the apparatus 1706. The reception component 1702 may provide received communications to one or more other components of the apparatus 1700. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1700. In some aspects, the reception component 1702 may include one or more antennas, a modem, a demodulator, a MIMO detector, a receive processor, a controller/processor, a memory, or a combination thereof, of the passive UE described in connection with FIG. 2.

The transmission component 1704 may transmit communications, such as reference signals, control information, data communications, or a combination thereof, to the apparatus 1706. In some aspects, one or more other components of the apparatus 1700 may generate communications and may provide the generated communications to the transmission component 1704 for transmission to the apparatus 1706. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1706. In some aspects, the transmission component 1704 may include one or more antennas, a modem, a modulator, a transmit MIMO processor, a transmit processor, a controller/processor, a memory, or a combination thereof, of the passive UE described in connection with FIG. 2. In some aspects, the transmission component 1704 may be co-located with the reception component 1702 in a transceiver.

The reception component 1702 may receive, from a first device, control information that configures the second device to operate as a passive device in association with selection of a multi-sine waveform. The reception component 1702 may receive the multi-sine waveform. The selection component 1710 may select the multi-sine waveform based at least in part on the control information. The transmission component 1704 may transmit an indication of the selected multi-sine waveform.

The transmission component 1704 may backscatter an identifier of the second device based at least in part on the selected multi-sine waveform.

The number and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

The following provides an overview of some Aspects of the present disclosure:

Aspect 1: A method of wireless communication performed by a first device, comprising: transmitting, to a second device, control information that configures the second device to operate as a passive device in association with selection of a multi-sine waveform; and transmitting the multi-sine waveform based at least in part on the control information.

Aspect 2: The method of Aspect 1, wherein the control information indicates an index of the multi-sine waveform.

Aspect 3: The method of any of Aspects 1-2, wherein the control information indicates one or more of a time domain backscattering occasion for selecting the multi-sine waveform or a frequency domain backscattering occasion for selecting the multi-sine waveform.

Aspect 4: The method of Aspect 3, wherein the frequency domain backscattering occasion is based at least in part on an impedance switching frequency.

Aspect 5: The method of Aspect 3, wherein the frequency domain backscattering occasion is based at least in part on an integer multiple of a subcarrier spacing, and wherein the multiple is based at least in part on a quantity of resource elements between frequency components of the multi-sine waveform.

Aspect 6: The method of any of Aspects 1-5, wherein the first device is a user equipment, and wherein the method includes receiving a first indication of one or more of a period length of the multi-sine waveform, a quantity of frequency components of the multi-sine waveform, or a bandwidth of the multi-sine waveform.

Aspect 7: The method of any of Aspects 1-6, further comprising receiving the control information from a network entity.

Aspect 8: The method of any of Aspects 1-7, wherein the first device is a network entity, and wherein the method includes transmitting a first indication of one or more of a period length of the multi-sine waveform, a quantity of frequency components of the multi-sine waveform, or a bandwidth of the multi-sine waveform.

Aspect 9: The method of any of Aspects 1-8, further comprising transmitting or receiving a second indication of an equal spacing of sine waves in the multi-sine waveform.

Aspect 10: The method of any of Aspects 1-9, further comprising transmitting or receiving a second indication of an unequal spacing of sine waves in the multi-sine waveform.

Aspect 11: The method of any of Aspects 1-10, further comprising transmitting or receiving a second indication of equal amplitudes of sine waves in the multi-sine waveform.

Aspect 12: The method of any of Aspects 1-11, further comprising transmitting or receiving a second indication of unequal amplitudes of sine waves in the multi-sine waveform.

Aspect 13: The method of any of Aspects 1-12, further comprising: receiving waveform selection feedback; and transmitting updated control information based at least in part on the waveform selection feedback.

Aspect 14: The method of Aspect 13, wherein the waveform selection feedback includes one or more of a signal-to-noise ratio associated with an identifier (ID) of the second device, a recommended modulation order associated with the ID of the second device, a recommended coding rate associated with the ID of the second device, a parameter, or a waveform index.

Aspect 15: The method of any of Aspects 1-14, further comprising receiving an indication of one or more of a period length of the multi-sine waveform, a quantity of frequency components of the multi-sine waveform, or a bandwidth of the multi-sine waveform.

Aspect 16: The method of any of Aspects 1-15, further comprising grouping passive devices that select a same multi-sine waveform for group backscattering.

Aspect 17: The method of any of Aspects 1-16, further comprising receiving, from the second device, backscattered data that is associated with a multi-sine waveform transmitted by the first device.

Aspect 18: A method of wireless communication performed by a second device, comprising: receiving, from a first device, control information that configures the second device to operate as a passive device in association with selection of a multi-sine waveform; receiving the multi-sine waveform; selecting the multi-sine waveform based at least in part on the control information; and transmitting an indication of the selected multi-sine waveform.

Aspect 19: The method of Aspect 18, wherein the control information indicates one or more of an index of the multi-sine waveform, a time domain backscattering occasion for selecting the multi-sine waveform, or a frequency domain backscattering occasion for selecting the multi-sine waveform.

Aspect 20: The method of Aspect 19, wherein the frequency domain backscattering occasion is based at least in part on an impedance switching frequency.

Aspect 21: The method of Aspect 19, wherein the frequency domain backscattering occasion is based at least in part on a multiple of a subcarrier spacing, and wherein the multiple is based at least in part on a quantity of resource elements between frequency components of the multi-sine waveform.

Aspect 22: The method of any of Aspects 18-21, wherein selecting the multi-sine waveform includes selecting the multi-sine waveform based at least in part on an energy state of the second device.

Aspect 23: The method of any of Aspects 18-22, further comprising backscattering an identifier of the second device based at least in part on the selected multi-sine waveform.

Aspect 24: A method of wireless communication performed by a third device, comprising: receiving backscattered data from a second device that is associated with a multi-sine waveform transmitted by a first device; and transmitting waveform selection feedback for the backscattered data based at least in part on waveform parameters that include one or more of a period length of the multi-sine waveform, a quantity of frequency components of the multi-sine waveform, or a bandwidth of the multi-sine waveform.

Aspect 25: The method of Aspect 24, wherein the third device is a network entity, and wherein the method includes transmitting the waveform parameters.

Aspect 26: The method of any of Aspects 24-25, wherein the third device is a user equipment, and wherein the method includes receiving the waveform parameters.

Aspect 27: The method of any of Aspects 24-26, wherein transmitting the waveform selection feedback includes transmitting the waveform selection feedback based at least in part on receiving the backscattered data from multiple passive devices in a same time domain backscattering occasion but in different frequency domain backscattering occasions.

Aspect 28: The method of Aspect 27, wherein the waveform selection feedback includes one or more of a signal-to-noise ratio associated with an identifier (ID) of the second device, a recommended modulation order associated with the ID of the second device, a recommended coding rate associated with the ID of the second device, a parameter, or a waveform index.

Aspect 29: An apparatus for wireless communication at a device, comprising a processor; memory coupled with the processor; and instructions stored in the memory and executable by the processor to cause the apparatus to perform the method of one or more of Aspects 1-28.

Aspect 30: A device for wireless communication, comprising a memory and one or more processors coupled to the memory, the one or more processors configured to perform the method of one or more of Aspects 1-28.

Aspect 31: An apparatus for wireless communication, comprising at least one means for performing the method of one or more of Aspects 1-28.

Aspect 32: A non-transitory computer-readable medium storing code for wireless communication, the code comprising instructions executable by a processor to perform the method of one or more of Aspects 1-28.

Aspect 33: A non-transitory computer-readable medium storing a set of instructions for wireless communication, the set of instructions comprising one or more instructions that, when executed by one or more processors of a device, cause the device to perform the method of one or more of Aspects 1-28.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A first device for wireless communication, comprising:
a memory; and
one or more processors, coupled to the memory, configured to:
transmit, to a second device, control information that configures the second device to operate as a passive device in association with selection of a multi-sine waveform; and
transmit the multi-sine waveform based at least in part on the control information.

2. The first device of claim 1, wherein the control information indicates an index of the multi-sine waveform.

3. The first device of claim 1, wherein the control information indicates one or more of a time domain backscattering occasion for selecting the multi-sine waveform or a frequency domain backscattering occasion for selecting the multi-sine waveform.

4. The first device of claim 3, wherein the frequency domain backscattering occasion is based at least in part on an impedance switching frequency or an integer multiple of a subcarrier spacing, wherein the multiple is based at least in part on a quantity of resource elements between frequency components of the multi-sine waveform.

5. (canceled)

6. The first device of claim 1, wherein the first device is a user equipment, and wherein the one or more processors are configured to receive a first indication of one or more of a period length of the multi-sine waveform, a quantity of frequency components of the multi-sine waveform, or a bandwidth of the multi-sine waveform.

7. The first device of claim 1, wherein the one or more processors are configured to receive the control information from a network entity.

8. The first device of claim 1, wherein the first device is a network entity, and wherein the one or more processors are configured to transmit a first indication of one or more of a period length of the multi-sine waveform, a quantity of frequency components of the multi-sine waveform, or a bandwidth of the multi-sine waveform.

9. The first device of claim 1, wherein the one or more processors are configured to transmit or receive a second indication of an equal spacing or unequal spacing of sine waves in the multi-sine waveform.

10. (canceled)

11. The first device of claim 1, wherein the one or more processors are configured to transmit or receive a second indication of equal amplitudes or unequal amplitudes of sine waves in the multi-sine waveform.

12. (canceled)

13. The first device of claim 1, wherein the one or more processors are configured to:
receive waveform selection feedback; and
transmit updated control information based at least in part on the waveform selection feedback;
wherein the waveform selection feedback includes one or more of a signal-to-noise ratio associated with an identifier (ID) of the second device, a recommended modulation order associated with the ID of the second device, a recommended coding rate associated with the ID of the second device, a parameter, or a waveform index.

14. (canceled)

15. The first device of claim 1, wherein the one or more processors are configured to receive an indication of one or more of a period length of the multi-sine waveform, a quantity of frequency components of the multi-sine waveform, or a bandwidth of the multi-sine waveform.

16. The first device of claim 1, wherein the one or more processors are configured to group passive devices that select a same multi-sine waveform for group backscattering.

17. The first device of claim 1, wherein the one or more processors are configured to receive, from the second device, backscattered data that is associated with a multi-sine waveform transmitted by the first device.

18. A second device for wireless communication, comprising:
a memory; and
one or more processors, coupled to the memory, configured to:
receive, from a first device, control information that configures the second device to operate as a passive device in association with selection of a multi-sine waveform;
receive the multi-sine waveform;
select the multi-sine waveform based at least in part on the control information; and
transmit an indication of the selected multi-sine waveform.

19. The second device of claim 18, wherein the control information indicates one or more of an index of the multi-sine waveform, a time domain backscattering occasion for selecting the multi-sine waveform, or a frequency domain backscattering occasion for selecting the multi-sine waveform.

20. The second device of claim 19, wherein the frequency domain backscattering occasion is based at least in part on an impedance switching frequency or a multiple of a subcarrier spacing, wherein the multiple is based at least in part on a quantity of resource elements between frequency components of the multi-sine waveform.

21. (canceled)

22. The second device of claim 18, wherein the one or more processors, to select the multi-sine waveform, are configured to select the multi-sine waveform based at least in part on an energy state of the second device.

23. The second device of claim 18, wherein the one or more processors are configured to backscatter an identifier of the second device based at least in part on the selected multi-sine waveform.

24. A third device for wireless communication, comprising:
a memory; and
one or more processors, coupled to the memory, configured to:
receive backscattered data from a second device that is associated with a multi-sine waveform transmitted by a first device; and
transmit waveform selection feedback for the backscattered data based at least in part on waveform parameters that include one or more of a period length of the multi-sine waveform, a quantity of frequency components of the multi-sine waveform, or a bandwidth of the multi-sine waveform.

25-26. (canceled)

27. The third device of claim 24, wherein the one or more processors, to transmit the waveform selection feedback, are configured to transmit the waveform selection feedback based at least in part on receiving the backscattered data from multiple passive devices in a same time domain backscattering occasion but in different frequency domain backscattering occasions;
wherein the waveform selection feedback includes one or more of a signal-to-noise ratio associated with an identifier (ID) of the second device, a recommended modulation order associated with the ID of the second device, a recommended coding rate associated with the ID of the second device, a parameter, or a waveform index.

28-30. (canceled)
